(19) United States
(12) Patent Application Publication
(10) Pub. No.: US 2007/0279934 A1
(43) Pub. Date: Dec. 6, 2007

(54) High output light guide panel and backlight unit employing the same

(75) Inventors: Young-chan Kim, Yongin-si (KR); Dong-ho Wee, Yongin-si (KR); Seung-ho Nam, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/698,207

(22) Filed: Jan. 26, 2007

(30) Foreign Application Priority Data
Jun. 2, 2006 (KR) 10-2006-0049994

(51) Int. Cl. F21V 7/04

(52) U.S. Cl. 362/607; 362/609; 362/620; 362/624

(57) ABSTRACT

Provided are a high output light guide panel and a backlight unit employing the same. The light guide panel includes a first layer having an incident surface on which light emitted from a light source is incident, a surface opposite the incident surface, and an upper surface through which the light exists. A second layer is disposed on the first layer and includes a continuous and periodic array of exit units and planar portions formed between the exit units, each exit unit having a first prism and a second prism which is equal to or larger than the first prism. A third layer is formed of an anisotropic material and is disposed on the second layer.

### CROSS-REFERENCE TO RELATED PATENT APPLICATION

This application claims priority from Korean Patent Application No. 10-2006-0049994, filed on Jun. 2, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a high output light guide panel from which high amounts of light exit upwardly and perpendicularly and a backlight unit employing the same, and more particularly, to a high output light guide panel having improved light efficiency by separating and converting light of different polarizations and a backlight unit employing the same.

2. Description of the Related Art

In general, liquid crystal displays (LCDs), which are light receiving type flat displays used in laptop computers, desktop computers, LCD TVs, and mobile communication terminals, do not have self-light emitting capability and thus, selectively transmit light irradiated from the outside to produce an image. Therefore, a backlight unit is disposed in the rear side of LCDs to emit light.

Backlight units can be classified as direct light type backlight units or edge light type backlight units according to the arrangement of a light source. A direct light type backlight unit includes a plurality of lamps that are installed directly under a liquid crystal display and emit light directly onto a liquid crystal panel.

A light source of the direct light type backlight unit can be installed in a desired position on a large surface and thus, is appropriate for a large screen display device such as an LCD TV. An edge light type backlight unit is appropriate for small or medium sized displays such as monitors or cell phones since the light source thereof is installed at a lateral side of a light guide panel.

FIG. 1 illustrates a light guide panel used in a related art edge light type backlight unit. The edge light type backlight unit includes a light source 10, a first layer 15 formed of an isotropic material, a second layer 18 disposed on the first layer 15, and a third layer 25 formed of an anisotropic material. The first layer 15 includes an incident surface 15a on which light emitted from the light source 10 is incident and a surface 15b opposite the incident surface 15a.

The second layer 18 is an adhesion layer having a prism array 20. The third layer 25 is a birefringence layer having a variable refractive index according to the polarization direction of incident light. For example, the third layer 25 has a first refractive index that is almost the same as the refractive indexes of the first and second layers 15 and 18 with respect to light of P polarization and has a second refractive index that is relatively larger than the refractive indexes of the first and second layers 15 and 18 with respect to light of S polarization. Therefore, the light of P polarization is not affected by the differences of the second refractive indexes at each boundary of the layers and is transmitted without refraction to the first layer 15, second layer 20, and third layer 25, while the light of S polarization is reflected at the boundary of the second layer 20.

FIGS. 2A through 2E illustrate amounts of light with respect to an angle of light exiting through the light guide panel of FIG. 1 when an angle θ of a prism in the prism array 20 is 50°, 60°, 70°, 80°, and 90°, respectively. Graphs A and B respectively illustrate the amounts of light in the X and Y directions indicated in FIG. 1. As evident from the graphs A and B, the largest amount of light that exits perpendicular to the light guide panel is when the prism angle θ is 50°. As the amount of light exiting perpendicular with respect to the light guide panel increases, a light efficiency increases and the distribution of light becomes more uniform.

Table 1 illustrates the amount of light exiting upwardly (Z direction) of the light guide panel and the amount of light reaching on the surface 15b, assuming that the amount of incident light is 100.

TABLE 1

| | Prism angle (°) | | | | |
|---|---|---|---|---|---|
| | 50 | 60 | 70 | 80 | 90 |
| Amount of | 50.61100 | 61.35100 | 69.33000 | 71.81500 | 67.61300 |
| light exiting | | | | | |
| upwardly | | | | | |
| Light | 30.91300 | 22.88000 | 16.41000 | 14.15700 | 14.69100 |
| reaching | | | | | |
| on surface | | | | | |
| 15b | | | | | |

Referring to Table 1, the maximum amount of light exiting upwardly is when the prism angle is 80°.

As described above, the light guide panel of FIG. 1 does not satisfy both conditions, that is, the maximum amount of light exiting upwardly and perpendicularly, at the same time. That is, if one is optimized, the other one cannot be optimized.

### SUMMARY OF THE INVENTION

Exemplary embodiments of the present invention provide a high output light guide panel from which a high amount of light exits upwardly and perpendicularly and, a backlight unit employing the same.

According to an aspect of the present invention, there is provided a light guide panel including: a first layer having an incident surface on which light emitted from a light source is incident, a surface opposite the incident surface, and an upper surface through which the light exits; a second layer disposed on the first layer and including a continuous and periodic array of exit units and planar portions formed between the exit units, each exit unit having a first prism and a second prism equal to or larger than the first prism; and a third layer comprising an anisotropic material on the second layer.

The first prism may have first and second planar surfaces and the second prism may have third and fourth planar surfaces, where the first and third surfaces having the same slope.

The first and second prisms may have the same angles and a height of the first prism may be equal to or less than a height of the second prism.

According to another aspect of the present invention, there is provided a backlight unit for irradiating a display with light, the backlight unit including: a light source; a first layer having an incident surface on which light emitted from a light source is incident, a surface opposite the incident surface, and an upper surface through which the light exits; a second layer disposed on the first layer and including a continuous and periodic array of exit units and planar portions formed between the exit units, each exit unit having a first prism and a second prism; and a third layer comprising an anisotropic material disposed on the second layer.

According to another aspect of the present invention, there is provided a light guide panel including: a first layer; a second layer disposed on the first layer including a continuous and periodic array of exit units and a planar portion disposed between each exit unit, each exit unit having a first prism, a second prism which is equal to or larger than the first prism, and a third prism which is equal to or larger than the second prism; and a third layer of an anisotropic material disposed on the second layer.

The first prism and the third prism may have the same size.

The first through the third prisms have the same angles and heights of the first and third prisms are less than height of the second prism.

According to another aspect of the present invention, there is provided a backlight unit for irradiating a display with light, the backlight unit including: a first layer having first and second sides opposite each other; first and second light sources formed on the first and second sides of the first layer, respectively; a second layer disposed on the first layer and including a continuous and periodic array of exit units and planar portions formed between the exit units, each exit unit having a first prism, a second prism which is equal to or larger than the first prism, and a third prism which is equal to or larger than the second prism; and a third layer comprising an anisotropic material disposed on the second layer.

According to another aspect of the present invention, there is provided a backlight unit for irradiating a display with light, the backlight unit including: a first layer having first and second sides opposite each other; a light source disposed on the first side of the first layer; a reflective plate disposed on the second side of the first layer; a second layer disposed on the first layer and including a continuous and periodic array of exit units and planar portions formed between the exit units, each exit unit having a first prism, a second prism which is equal to or larger than the first prism, and a third prism which is equal to or larger than the second prism; and a third layer comprising an anisotropic material disposed on the second layer.

### BRIEF DESCRIPTION OF THE DRAWINGS

The above and other aspects of the present invention will become more apparent by the following detailed description of exemplary embodiments thereof with reference to the attached drawings in which:

FIG. 1 is a diagram of a related art light guide panel in which a prism array is formed on an adhesion layer;

FIGS. 2A through 2E respectively illustrate amounts of light exiting perpendicularly through the light guide panel of FIG. 1, the amounts of light being measured when an angle of a prism in the prism array in the light guide panel is 50°, 60°, 70°, 80°, and 90°;

FIG. 3 is a diagram of a light guide panel according to an exemplary embodiment of the present invention;

FIG. 4 illustrates a process of light exiting from an exit unit of the light guide panel of FIG. 3;

FIG. 5A illustrates the amount of light exiting upwardly through the light guide panel of FIG. 3;

FIG. 5B illustrates the amount of light exiting perpendicularly through the light guide panel of FIG. 3.

FIG. 6 is a diagram of a light guide panel according to another exemplary embodiment of the present invention; and

FIG. 7 is a diagram of a display employing the light guide panel according to an exemplary embodiment of the present invention.

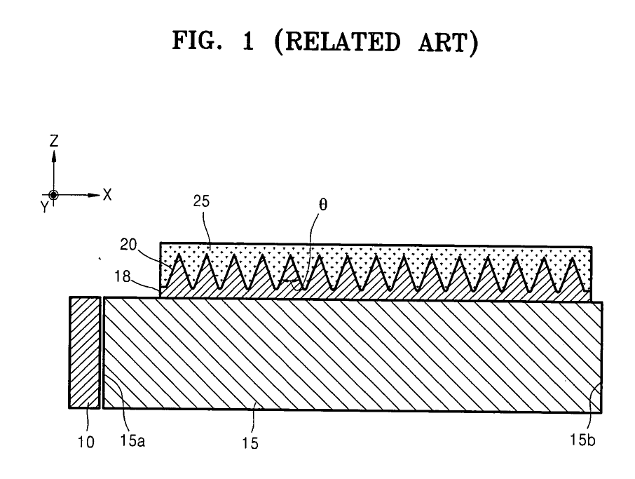

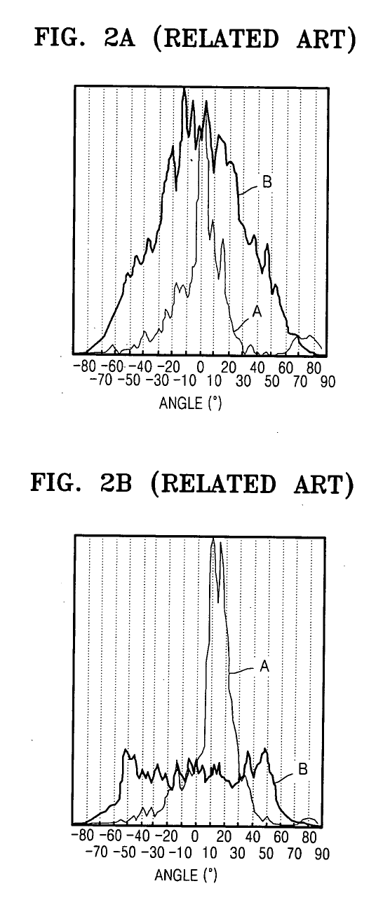

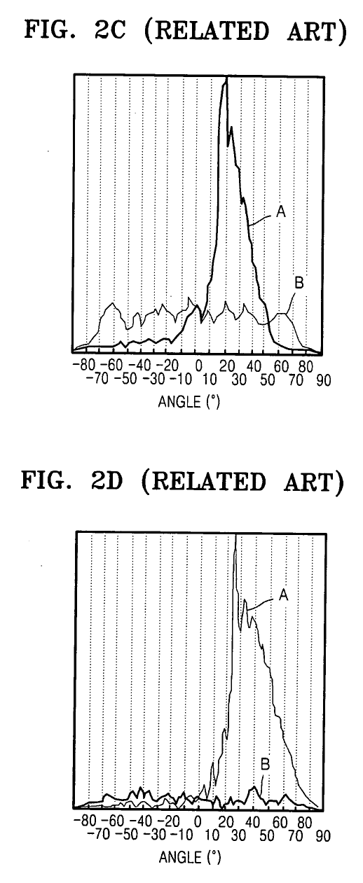

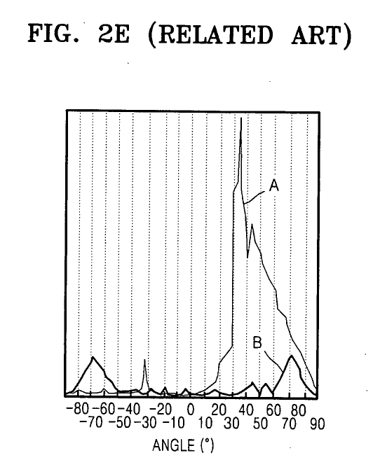

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

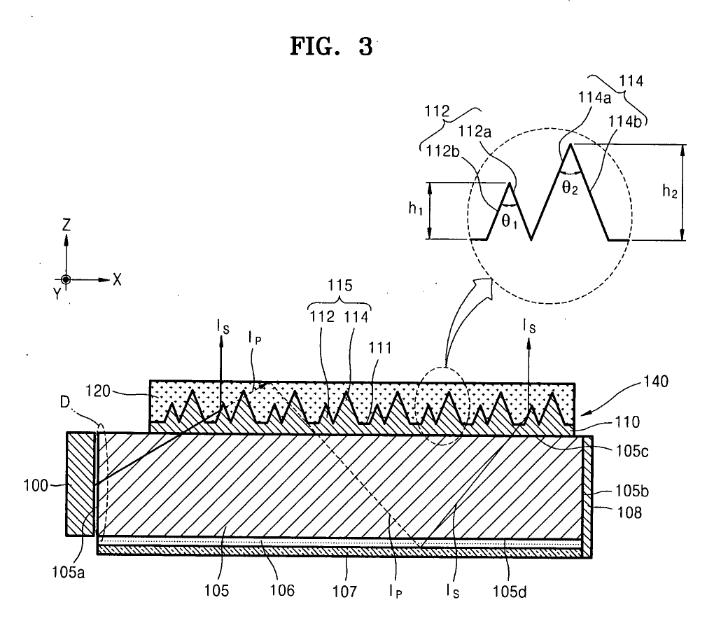

FIG. 3 is a diagram of a backlight unit and a light guide panel according to an embodiment of the present invention.

Referring to FIG. 3, a backlight unit according to an exemplary embodiment of the present invention includes a light source 100 and a light guide panel 140 guiding light emitted from the light source 100. The light guide panel 140 includes a first layer 105 guiding light emitted from the light source 100, a second layer 110 disposed on the first layer 105, and a third layer 120 formed of an anisotropic material.

The first layer 105 has an incident surface 105a, a surface 105b opposite the incident surface 105a, an upper surface 105c through which the light exits, and a lower surface 105d opposite the upper surface 105c.

In order to improve the efficiency of light exiting through the upper surface 105c and light polarization conversion, the light guide panel 140 includes a polarization converting plate 106 disposed on the lower part of the lower surface 105d, a lower reflective plate 107 disposed on the lower part of the polarization converting plate 106, and a side reflective plate 108 disposed on the surface 105b. In order to convert a polarization direction of incident light, a ¼-wavelength plate or other converting means can be used for the polarization converting plate 106 or the polarization converting plate 106 can be disposed on the side of the surface 105b.

The second layer 110 has a continuous and periodic array of exit units 115, each exit unit 115 including a first prism 112 and a second prism 114 that are adjacent to each other. Planar portions 111 are formed between the exit units 115.

The third layer 120 formed of anisotropic materials has different refractive characteristics according to a polarization direction of incident light. In other words, the third layer 120 has birefringence characteristics, i.e., first and second refractive indices with respect to light beams of first and second polarizations, respectively. Examples of the anisotropic materials may be PolyEthyleneTerephthalate (PET), PolyButylene-Terephthalate (PBT), and PolyEthyleneNaphthalate (PEN). The first and second layers 105 and 110 may be formed of an isotropic material having the same or almost the same refractive indices. For example, the first and second layers 105 and 110 may be formed of polymethyl methacrylate (PMMA) and resin having refractive indices of 1.49 and 1.5, respectively. In addition, the first and second layers 105 and 10 may be integrally formed of the same materials. The third layer 120 may have a first refractive index that is almost equal to those of the first and second layers 105 and 110 with respect to a light beam of P polarization and a second refractive index that is relatively larger than the refractive indices of the first and second layers 105 and 110 with respect to a light beam of S polarization. Therefore, there is no difference in the refractive indices at interfaces of each layer when a light beam of P polarization penetrates through the first through third layers 105, 110, and 120. The ideal case is when the first, second, and third layers 105, 110, and 120 have the same first refractive index and the second refractive index is relatively greater than the first refractive index. In this case, the light beam of P polarization travels through the first through third layers as if passing through a single layer of uniform material.

The exit unit 115 is formed of the first prism 112 and the second prism 114. The first and second prisms may each comprise at least two planar surfaces. In FIG. 3, the first prism 112 is formed of first and second planar surfaces 112a and 112b and the second prism 114 is formed of third and fourth planar surfaces 114a and 114b. The height (h1) of the first prism 112 is the same or shorter than the height (h2) of the second prism 114. The slope of the first planar surface 112a is the same as the slope of the third planar surface 114a. Since the slope of the first and third planar surfaces is an important factor that determines the condition of total reflection of incident light to the first and second prisms, the first and third planar surfaces have the same slope. That is, an angle of incidence of the incident light depends on the slope of the first and third planar surfaces. Also, the angle of incidence is determined in order to satisfy the condition of the total reflection. Moreover, the angles of the first and second prisms θ1 and θ2 may be the same. The incident light from the planar portion 111 exits through the top of the exit unit 115; this will be described more fully later.

In FIG. 3, the areas of second and third layers 110 and 120 are smaller than that of the first layer 105 because a dark portion and a bright line are formed on the incident surface 105a. That is, a screen excluding the dark portion and the bright line is used as an effective screen. However, in the absence of the dark portion and the bright line, the areas of each of the first through third layers 105, 110, and 120 can be made equal to each other.

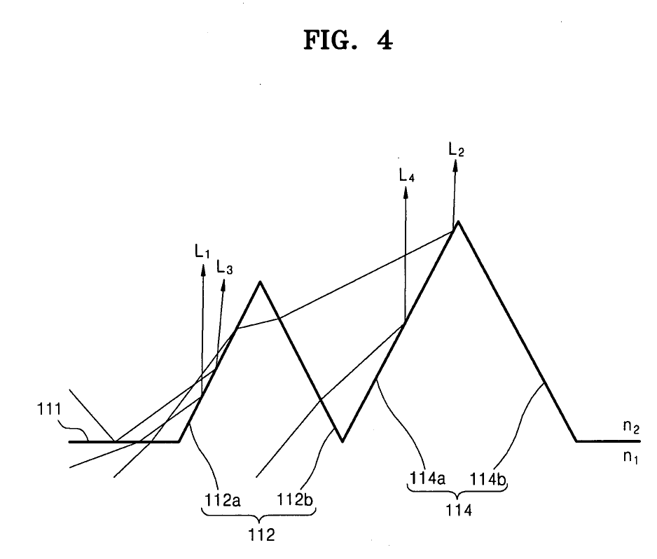

The operation of the light guide panel 140 will now be described with reference to FIGS. 3 and 4.

Light emitted from the light source 100 is radiated in all directions. After light is incident on the first layer 105, the radiation range of the light is reduced according to the refractive index of the first layer 105. For example, when the refractive index of the first layer 105 is 1.49, light incident from air to the first layer 105 has a range of radiation angles of ±42 degree. Light transmitted downward from the first layer 105 is totally reflected at the lower part of the light guide panel 140 or is reflected at the lower reflective plate 107 to be transmitted upward. Also, light transmitted upward of the first layer 105 is refracted through the second layer 110. Light incident on the second layer 110 passes through the planar portion 111 and the first through fourth surfaces 112a, 112b, 114a, and 114b and is incident on the third layer 120. The first and second layers 105 and 110 are formed of isotropic materials and thus, are not affected by the polarization direction of incident light, while light incident on the third layer 120 has different refractive characteristics according to its polarization direction and thus, is transmitted along different paths according to its polarization direction. When a first refractive index ‘no’ of the third layer 120 with respect to light Ip of first polarization is substantially the same with the refractive index of the second layer 110 and a second refractive index ‘ne’ of the third layer 120 with respect to light Is of second polarization is greater than the refractive index of the second layer 110, the light Ip of the first polarization and the light Is of the second polarization are separated at the interface between the second layer and the third layer 120. The light Ip of the first polarization is incident on the third layer 120 at an angle greater than the critical angle and then is reflected from the top surface of the third layer 120, while the light Is of the second polarization is incident on the third layer 120 at an angle less than a critical angle and then is transmitted through a top surface of the third layer 120. That is, most of the incident light Is of the second polarization is transmitted at an angle that is almost perpendicular to the upper surface of the third layer 120.

In more detail, the operation of the light guide panel 140 with respect to light transmission of the second polarization, according to the position of the incident light at the interfaces of the second and third layers 110 and 120 is as follows. The light Ip of the first polarization passes through the first through the third layers without a change of the refractive index and thus, the light Ip is reflected from the upper surface of the third layer back toward the first layer. Hereinafter, light of the second polarization is described only.

Referring to FIG. 4, first light L1, for total reflection, is among light incident on the first planar surface 112a of the first prism 112 after being reflected from the planar portion 111, and is reflected from the first planar surface 112a to exit through the top of the light guide panel. Second light L2 is not suitable for total reflection is among the light incident on the first planar surface 112a of the first prism 112 after being reflected from the planar portion 111, and is reflected at the third planar surface 114a of the second prism 114. If the second light L2 satisfies the reflection condition, the light is reflected from the third planar surface 114a to exit through the top of the light guide panel.

Third light L3, which is among the light traveling downward after being reflected from the upper surface of the third layer, is reflected from the planar portion 111 and then, is reflected again from the first planar surface 112a of the first prism 112 to exit through the top of the light guide panel. Fourth light L4, which is incident on the second planar surface 112b of the first prism 112, and is among the light reaching the first layer 105, is reflected from the second planar surface 112b and then, is totally reflected from the third planar surface 114a of the second prism 114 to exit through the top of the light guide panel.

When a portion of the light reaching the first layer 105 passes through the fourth planar surface 114b of the second prism 114, that light is totally reflected from the upper surface of the third layer 120 and exits through the top of the light guide panel along the same path as the third light L3.

As described above, since most light penetrating the planar portion 111 and the second planar surface 112b exits perpendicularly through the top of the light guide panel, both the amount of light exiting upwardly and the amount of light exiting perpendicularly are increased. The first prism 112 totally reflects the light incident on the first planar surface 112a of the first prism 112 with respect to the second prism 114, when the light does not satisfy the condition of total reflection.

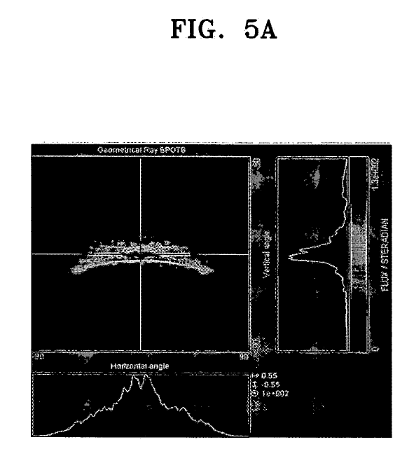

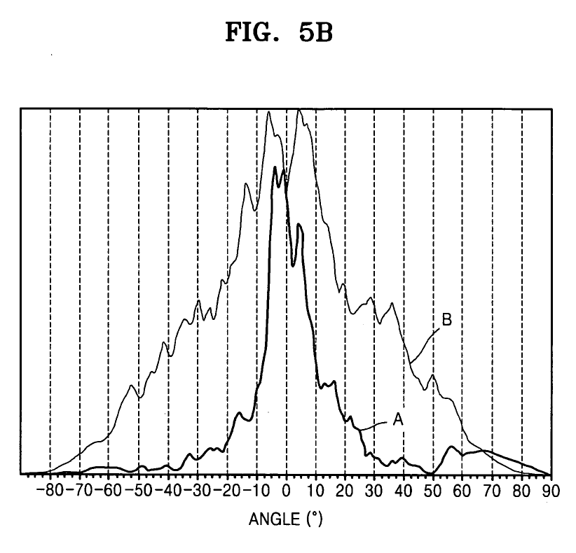

FIGS. 5A and 5B illustrate the amount of light exiting upwardly and the range of angles at which light exits with respect to the light guide panel, respectively. In this case, θ1 and θ2=50°, h1=10 μm, and h2=21.5 μm. The amount of light exiting through the light guide panel is 70.90771 when the amount of incident light is 100. Graphs A and B in FIG. 5B respectively illustrate the ranges of angles at which light exits in the X and Y directions indicated in FIG. 3. As evident from the graph A, the amount of light exiting perpendicularly is large.

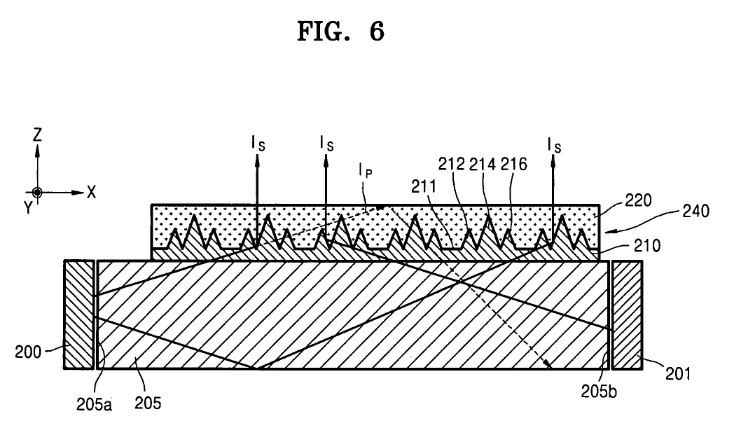

FIG. 6 is a diagram of a backlight unit and a light guide panel 240 according to another exemplary embodiment of the present invention.

Referring to FIG. 6, the backlight unit according to another exemplary embodiment of the present invention includes a first light source 200 and a second light source 201 disposed on opposite sides of a light guide panel 240. The light guide panel 240 includes a first layer 205 which guides light emitted from the first and second light sources 200 and 201, a second layer 210 disposed on the first layer 205, and a third layer 220 formed of an anisotropic material.

The first layer 205 has a first incident surface 205a on which light is incident from the first light source 200 and a second incident surface 205b opposite the first incident surface 205a on which light is incident from the second light source 201. In addition, according to the present embodiment, a reflective plate may be disposed instead of the second light source 201.

As illustrated in FIG. 3, the light guide panel 240 may further include a polarization converting plate disposed on the lower part of the lower surface of the light guide panel 240 and a lower reflective plate formed on the lower part of the polarization converting plate (not illustrated).

The second layer 210 has a continuous and periodic array of exit units 215, each exit unit 215 including a first prism 212, a second prism 214, and a third prism 216. Planar portions 211 are formed between the exit units 215.

The first through third prisms 212, 214, and 216 may have the same size. In addition, the first and third prisms 212 and 216 may be smaller than the second prism 214. In this case, the first and third prisms 212 and 216 may have the same size as each other. When the first through third prisms 212, 214, and 216 have the same prism angles, the process of manufacturing the prisms can be simplified. The first and third prisms 212 and 216 totally reflect light emitted from the first and second light source 200 and 201. The second prism 214 reflects the light upwardly and the light exits through top of the third layer 220, wherein the light incident on the second prism 214 through the first and third prisms 212 and 216.

The third layer 220 formed of the anisotropic materials has different refractive characteristics according to a polarization direction of incident light. In other words, the third layer 220 has birefringence characteristics, i.e., first and second refractive indices with respect to light beams Ip and Is of first and second polarizations, respectively. The first refractive index is almost equal to that of the first and second layers 205 and 210 and the second refractive index is larger than that of the first and second layers 205 and 210. The light path of light emitted from the first light source 200 is separated at the interface between the second and third layers 210 and 220 according to light polarization.

Light emitted from the first light source 200 passes through the first and second layers 205 and 210 and the light path of light of the first and second polarization Ip and Is is changed at the first and second prisms 212 and 214 to be transmitted through the third layer 220. In addition, the light of the first polarization Ip is reflected from the upper surface of the third layer 220 toward the first layer 205 and the light of the second polarization Is exits through the upper surface of the third layer 220. On the other hand, light emitted from the second light source 201 passes through the first and second layers 205 and 210 and the light path of light of the first and second polarization Ip and Is is changed at the second and third prisms 214 and 216 to be transmitted through the third layer 220. In addition, the light of the first polarization Ip is reflected from the upper surface of the third layer 220 toward the first layer 205 and light of the second polarization Is exits through the upper surface of the third layer 220. Since the first and second prisms 212 and 214, with respect to the light emitted from the first light source 200, and the second and third prisms 214 and 216, with respect to the light emitted from the second light source 201, are the same with those described with respect to FIG. 4, a detailed description thereof will not be given.

The first prism 212 and the third prism 216 can be symmetrical with respect to the second prism 214 and operate in the same manner for light emitted from first and second light sources 200 and 201. A polarization converting plate and a reflective plate (not illustrated) may be further disposed on the lower surface of the first layer 105.

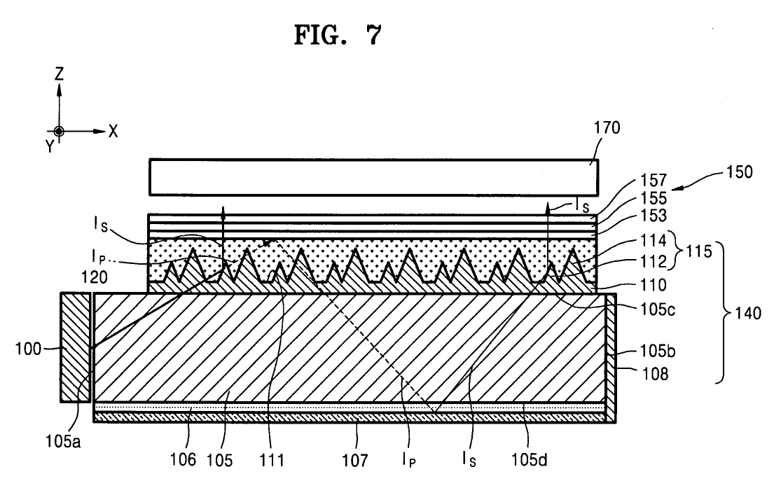

FIG. 7 is a diagram of a display employing the light guide panel according to an exemplary embodiment of the present invention.

Referring to FIG. 7, the display includes a backlight unit 150 and a display panel 170 producing an image using light emitted from the backlight unit 150. The backlight unit 150 includes a light source 100 and a light guide panel 140 guiding light emitted from the light source 100 toward the display panel 170. Because the light guide panel 140 has the same configuration and operational effect as described above, a detailed description thereof will not be given.

The backlight unit 150 further includes a diffusion plate 153 which diffuses light, a first prism sheet 155 which corrects the transmitting path of light, and a second prism sheet 157 disposed between the light guide panel 140 and the display panel 170. The first and second prism sheets 155 and 157 are arranged perpendicular to each other and thus, refract and focus light output from the diffusion plate 153 in order to improve the directionality of the light, thereby increasing the light brightness and reducing the incident angle of light. Optical sheets and components disposed between the light guide panel 140 and the display panel 170 can exhibit better performances when they can conserve polarization direction. According to the characteristics of light exiting from the display panel, the display panel can be assembled without using the first and second prism sheets 155 and 157 and the diffusion plate 153.

The display panel 170 may be an LCD panel. The LCD panel uses only light of a specific polarization as effective light. In the present invention, the light is separated at the third layer 120 included in the light guide panel which is formed of anisotropic materials and thus, only a light beam having specific polarization exits upwardly from the third layer 120. Therefore, a separate polarizing film for separating polarizations is not required. In addition, a polarization converting plate 106 and a reflective plate 107 may be further included on the lower surface of the first layer 105 to improve light efficiency.

As described above, the light guide panel according to exemplary embodiments of the present invention includes a plurality of exit units including a plurality of prisms and planar portions between the exit units to increase the amount of light exiting both upwardly and perpendicularly, thereby achieving high output power.

A backlight unit employing the light guide panel according to exemplary embodiments of the present invention provides images of high brightness with high output power. The backlight unit includes a layer formed of an anisotropic material on the upper surface of the light guide panel to separate light of different polarizations at the light guide panel and thus, only a light beam of one polarization is allowed to exit upwardly. Therefore, the backlight unit has a simple structure since a separate polarizing film for separating lights of different polarizations is not required.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light guide panel comprising:
a first layer comprising an incident surface, on which light emitted from a light source is incident, a surface opposite the incident surface, and an upper surface through which the light exits;
a second layer disposed on the first layer and comprising a continuous and periodic array of exit units and planar portions formed between the exit units, each exit unit comprising a first prism and a second prism which is equal in size to or larger than the first prism; and
a third layer comprising an anisotropic material disposed on the second layer.

2. The light guide panel of claim 1, wherein the first prism has first and second planar surfaces and the second prism has third and fourth planar surfaces, and the first and third surfaces have the same slope.

3. The light guide panel of claim 1, wherein the first and second prisms have the same angles and a height of the first prism is equal to or less than a height of the second prism.

4. A backlight unit for irradiating a display with light, the backlight unit comprising:
a light source;
a first layer comprising an incident surface on which light emitted from a light source is incident, a surface opposite the incident surface, and an upper surface through which the light exits;
a second layer disposed on the first layer comprising a continuous and periodic array of exit units and planar portions formed between the exit units, each exit unit comprising a first prism and a second prism; and
a third layer comprising an anisotropic material disposed on the second layer.

5. The backlight unit of claim 4, wherein the first prism has first and second planar surfaces and the second prism has third and fourth planar surfaces, and the first and third surfaces have the same slope.

6. The backlight unit of claim 4, wherein the first and second prisms have the same angles and a height of the first prism is equal to or less than a height of the second prism.

7. The backlight unit of claim 4, further comprising a polarization converting plate disposed on the lower surface of the first layer, which converts a polarization direction of incident light.

8. A light guide panel comprising:
a first layer;
a second layer disposed on the first layer and comprising a continuous and periodic array of exit units and planar portions formed between the exit units, each exit unit comprising a first prism, a second prism which is equal to or larger than the first prism, and a third prism which is equal to or larger than the second prism; and
a third layer comprising an anisotropic material disposed on the second layer.

9. The light guide panel of claim 8, wherein the first prism and the third prism have the same size.

10. The light guide panel of claim 8, wherein the first, second, and third prisms have the same angles and heights of the first and third prisms are less than a height of the second prism.

11. A backlight unit for irradiating a display with light, the backlight unit comprising:
a first layer comprising first and second sides, opposite each other;
first and second light sources disposed on the first and second sides of the first layer, respectively;
a second layer disposed on the first layer and comprising a continuous and periodic array of exit units and planar portions formed between the exit units, each exit unit comprising a first prism, a second prism which is equal to or larger than the first prism, and a third prism which is equal to or larger than the second prism; and
a third layer comprising an anisotropic material disposed on the second layer.

12. The backlight unit of claim 11, wherein the first prism and the third prism have the same shape.

13. The backlight unit of claim 11, wherein the first, second, and third prisms have the same angles and heights of the first and third prisms are shorter than a height of the second prism.

14. The backlight unit of claim 11, further comprising a polarization converting plate disposed on a lower surface of the first layer, which converts a polarization direction of incident light.

15. A backlight unit for irradiating a display with light, the backlight unit comprising:
a first layer comprising first and second sides, opposite each other;
a light source disposed on the first side of the first layer;
a reflective plate disposed on the second side of the first layer;
a second layer disposed on the first layer and comprising a continuous and periodic array of exit units and planar portions formed between the exit units, each exit unit comprising a first prism, a second prism which is equal to or larger than the first prism, and a third prism which is equal to or larger than the second prism; and
a third layer comprising an anisotropic material on the second layer.

16. The backlight unit of claim 15, wherein the first prism and the third prism have the same shape.

17. The backlight unit of claim 15, wherein the first, second, and third prisms have the same angles and heights of the first and third prisms are less than a height of the second prism.

18. The backlight unit of claim 15, further comprising a polarization converting plate disposed on a lower surface of the first layer which converts a polarization direction of incident light.
